(19) United States
(12) Patent Application Publication
(10) Pub. No.: US 2009/0107263 A1
(43) Pub. Date: Apr. 30, 2009

(54) PENDULUM-TYPE MEASURING DEVICE

(76) Inventor: NEN-TSUA LI, Taichung (TW)

Correspondence Address: G. LINK CO., LTD., 3550 BELL ROAD, MINOOKA, IL, 60447, US

(21) Appl. No.: 11/925,324

(22) Filed: Oct. 26, 2007

(51) Int. Cl. G01M 19/00

(52) U.S. Cl. 73/865.3

(57) ABSTRACT

A pendulum-type measuring device is disclosed that includes a steel ball-type universal joining mechanism for joining a pendulum with a base, and a laser measuring assembly mounted on the pendulum wherein a swing of the pendulum can be expressed as a first component on a first plane and a second component on a second plane perpendicular to the first plane.

### BACKGROUND OF THE INVENTION

1. Field of Invention

The invention relates to measuring devices and more particularly to a measuring device having a steel ball-type universal joining mechanism for joining a pendulum with a base, and a laser measuring assembly mounted on the pendulum in which a swing of the pendulum can be expressed as a first component on a first plane and a second component on a second plane perpendicular to the first plane.

2. Description of Related Art

A conventional laser measuring device is typically provided with a bearing-type joining mechanism for joining a pendulum with its base, and a laser measuring assembly pivotably secured to the pendulum. Laser elements of the laser measuring assembly are adapted to emit laser light beams from one of different directions toward a desired position.

However, the well known bearing-type joining mechanism for laser measuring device suffers from a disadvantage. In detail, bearings are subject to wearing. Thus, precision of the laser measuring device is lowered greatly after a short period time of use. Thus, a need for improvement exists.

### SUMMARY OF THE INVENTION

It is therefore one object of the invention to provide a measuring device having a steel ball-type universal joining mechanism for joining a pendulum with a base, and a laser measuring assembly mounted on the pendulum in which a swing of the pendulum can be expressed as a horizontal component and a vertical component. By utilizing this measuring device, measurement precision in both horizontal and vertical directions can be increased greatly.

The above and other objects, features and advantages of the invention will become apparent from the following detailed description taken with the accompanying drawings.

### BRIEF DESCRIPTION OF THE DRAWINGS

FIG. 1 is an exploded view of a first preferred embodiment of pendulum-type measuring device according to the invention;

FIG. 2 is a perspective view of the assembled measuring device;

FIG. 3 is a partially broken away view of the measuring device of FIG. 2;

FIG. 4 is a side elevation of FIG. 2 in part section;

FIG. 5 is a view similar to FIG. 4 where the inner ring, the outer ring and the top plate are inclined and a relative position of the inner ring and the cylinder is shown after a swing;

FIG. 6 is another side elevation of FIG. 2 in part section;

FIG. 7 is a view similar to FIG. 6 where the inner ring, the outer ring and the top plate are inclined and a relative position of the inner ring and the outer ring is shown after a swing;

FIG. 8 is an exploded view of a second preferred embodiment of pendulum-type measuring device according to the invention;

FIG. 9 is a perspective view of the assembled measuring device of FIG. 8;

FIG. 10 is a partially broken away view of the measuring device of FIG. 9;

FIG. 11 is a top plan view of FIG. 8;

FIG. 12 is a sectional view taken along line Y-Y of FIG. 11;

FIG. 13 is a view similar to FIG. 12 where the laser measuring assembly has swung relative to Y-axis;

FIG. 14 is a sectional view taken along line X-X of FIG. 11;

FIG. 15 is a view similar to FIG. 14 where the laser measuring assembly has swung relative to X-axis;

FIG. 16 is an exploded view of a third preferred embodiment of pendulum-type measuring device according to the invention;

FIG. 17 is a perspective view of the assembled measuring device of FIG. 16;

FIG. 18 is a side elevation of FIG. 17 in part section;

FIG. 19 is a front view of FIG. 17 where the laser measuring assembly has not swung; and

FIG. 20 is a view similar to FIG. 19 where the laser measuring assembly has swung relative to X-axis.

### DETAILED DESCRIPTION OF THE INVENTION

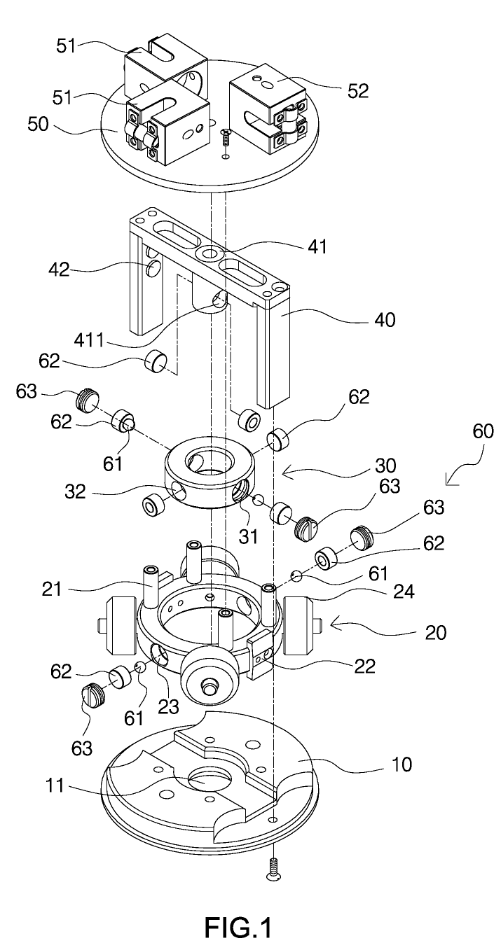

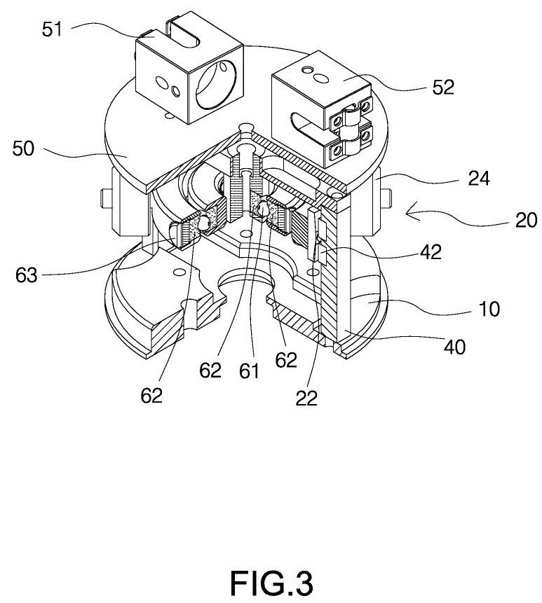

Referring to FIGS. 1 to 7, a pendulum-type measuring device in accordance with a first preferred embodiment of the invention is shown and comprises a disc-shaped base 10 having a central through hole 11; an inverted U-shaped bridge 40 threadedly secured to the base 10 and including a hollow cylinder 41 extending downward from a top center, the cylinder 41 having two opposite holes 411 proximate a lower end, and two opposite first magnets 42 each on an inner surface of either vertical portion.

The measuring device further comprises an inner ring 30 including two opposite first through holes 31 having threads on an outer portion, and two opposite holes 32 wherein an angle between either first through hole 31 and any adjacent hole 32 is 90 degrees; and an outer ring 20 including four upward extending posts 21 with internal threads, two opposite second magnets 22 on an outer surface, two opposite second through holes 23 wherein an angle between either second through hole 23 and any adjacent second magnet 22 is 90 degrees, and four equally spaced apart weights 24 wherein each second magnet 22 or second through hole 23 is provided between two adjacent weights 24.

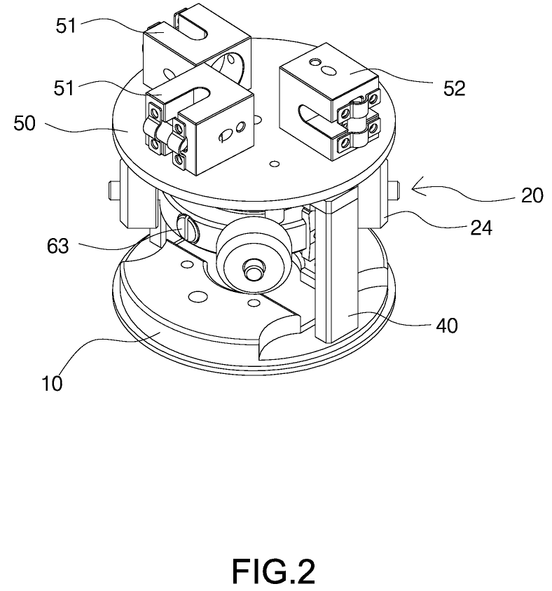

The measuring device further comprises four joining assemblies 60 having a steel ball 61, two concave members 62, and a threaded fastener 63; and a top plate 50 with a laser measuring assembly mounted thereon. As shown in FIG. 2, the laser measuring assembly comprises a horizontal laser measuring member 52 and two vertical laser measuring members 51.

Assembly of the first preferred embodiment of the invention will be described in detail below. First, use fasteners (e.g., screws) to secure the base 10 to the bridge 40. Next, mount two concave members 62 in the holes 411 respectively. Next, mount another two concave members 62 in the holes 32 respectively. Next, mount two steel balls 61 in the concave members 62 in the holes 411 respectively. Next, mount another two concave members 62 in the first through holes 31 to engage with the steel balls 61 respectively. Next, drive two threaded fasteners 63 into the first through holes 31 respectively for securing the concave members 62 and the steel ball 61 together in which the steel ball 61 is adapted to rotate freely in a space defined by the opposite concave members 62. This finishes the assembly of the bridge 40 and the inner ring 30. Next, mount another two steel balls 61 in the holes 32 to engage with the concave members 62 respectively. Next, mount another two concave members 62 in the second through holes 23 to engage with the steel balls 61 respectively. Next, drive another two threaded fasteners 63 into the second through holes 23 respectively for securing the concave members 62 and the steel ball 61 together in which the steel ball 61 is adapted to rotate freely in a space defined by the opposite concave members 62. This finishes the assembly of the outer ring 20 and the inner ring 30. At this position, the first magnet 42 at either side of the bridge 40 is aligned with and is spaced apart from the corresponding second magnet 22. Next, drive fasteners (e.g., screws) through the top plate 50 into the posts 21 to secure the top plate 50 and the outer ring 20 together. Finally, mount two vertical laser measuring members 51 and one horizontal laser measuring member 52 on the top plate 50. It is seen that both the base 10 and the bridge 40 are fixed and the remaining components including the inner ring 30, the outer ring 20, and the top plate 50 are adapted to swing as detailed later.

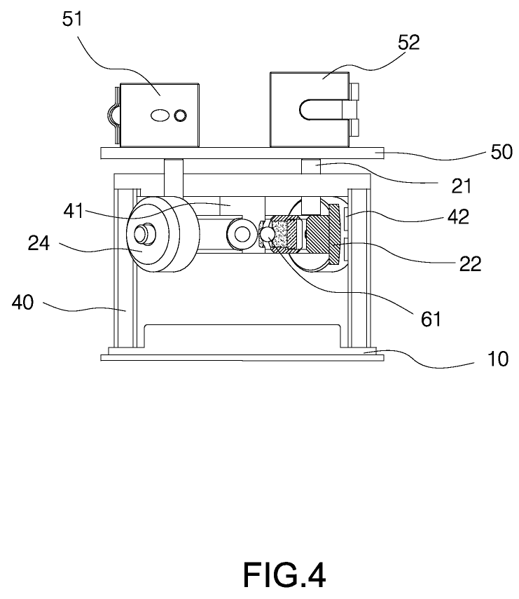

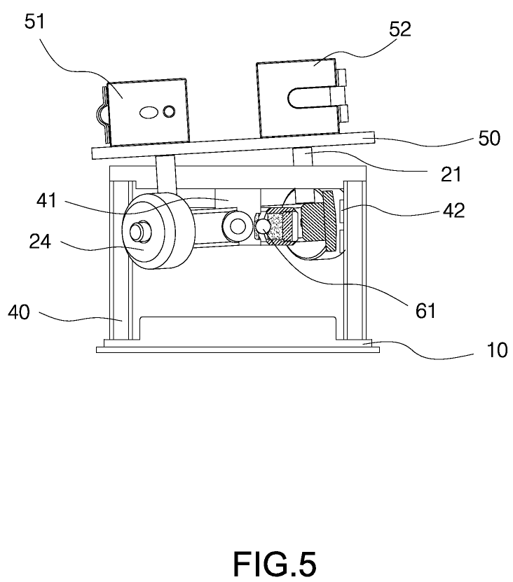

Referring to FIGS. 4 and 5 specifically, in a measuring operation the measuring device of the invention swings an angle which can be expressed as a horizontal component (i.e., swinging a first angle relative to X-axis) and a vertical component (i.e., swinging a second angle relative to Y-axis). In FIG. 4, a relative position of the inner ring 30 and the cylinder 41 before swing is shown. Further, in FIG. 5, a relative position of the inner ring 30 and the cylinder 41 after swing is shown. It is seen that the vertical laser measuring members 51 and the horizontal laser measuring member 52 are inclined (see FIG. 5).

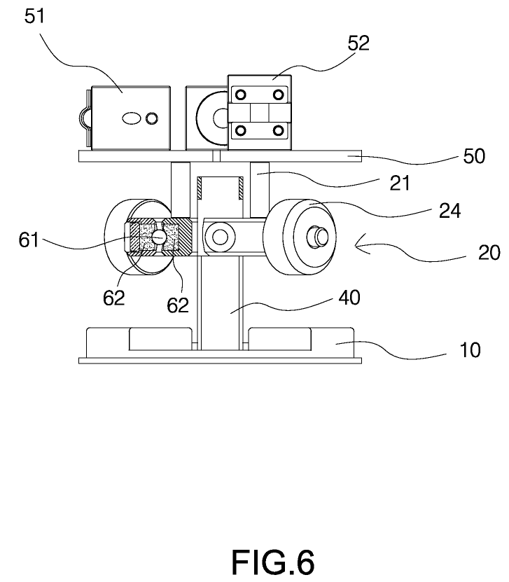

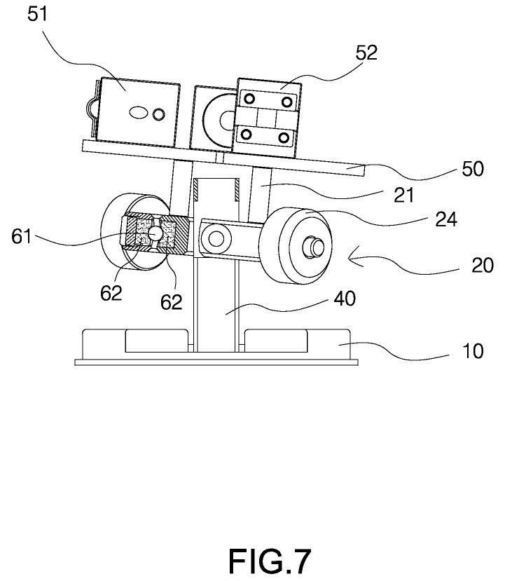

Referring to FIG. 6 specifically, a relative position of the inner ring 30 and the outer ring 20 before the swing is shown. Referring to FIG. 7 specifically, a relative position of the inner ring 30 and the outer ring 20 after the swing is shown. Horizontal and vertical lines for a measuring operation thus can be obtained.

The provision of the weights 24 aims to smooth the swinging of the outer ring 20. The polarity of the first magnet 42 is opposite to that of the second magnet 22. Thus, after a small angle swinging of the outer ring 20 relative to the bridge 40, the outer ring 20 will automatically return to its original position relative to the bridge 40 after the force causing the swing has been removed due to magnetic attraction as known in the art.

Alternatively, the measuring device of the invention can be employed as a laser level.

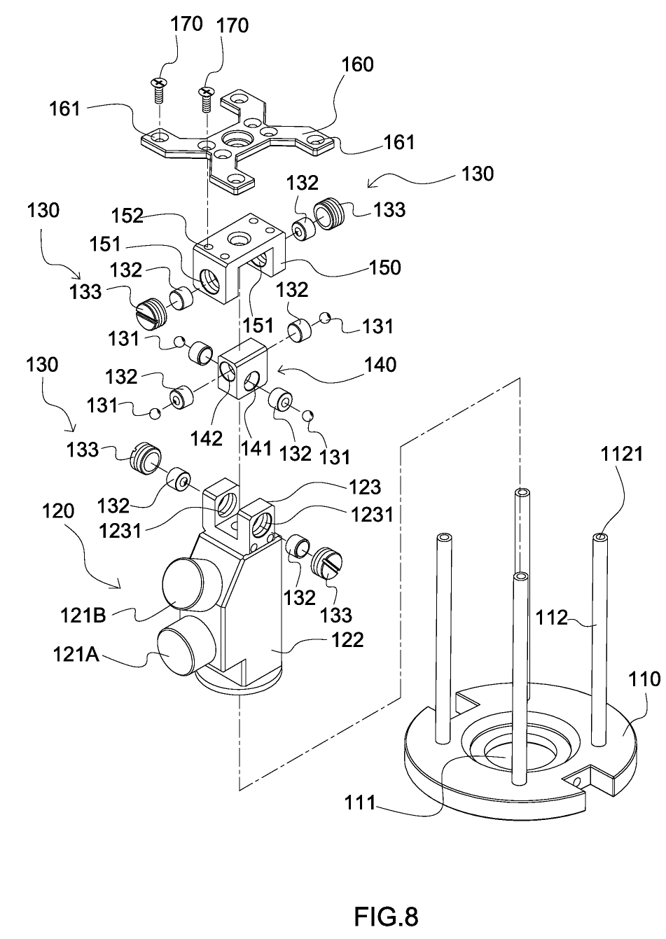

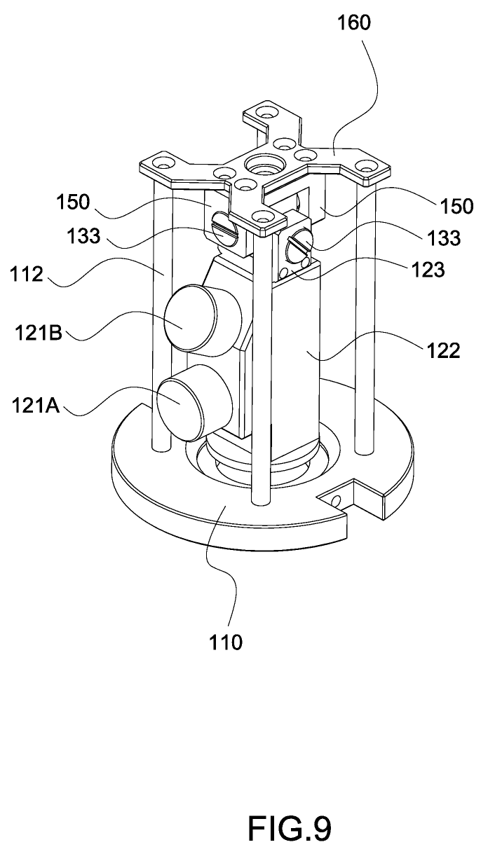

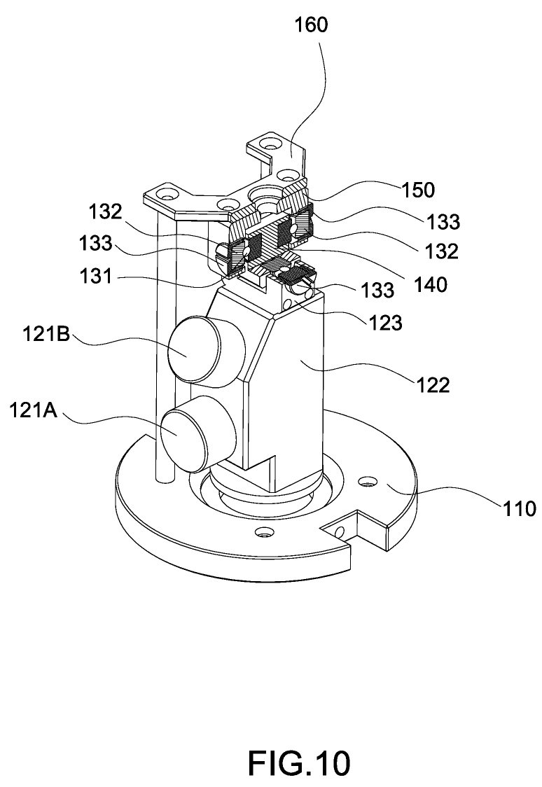

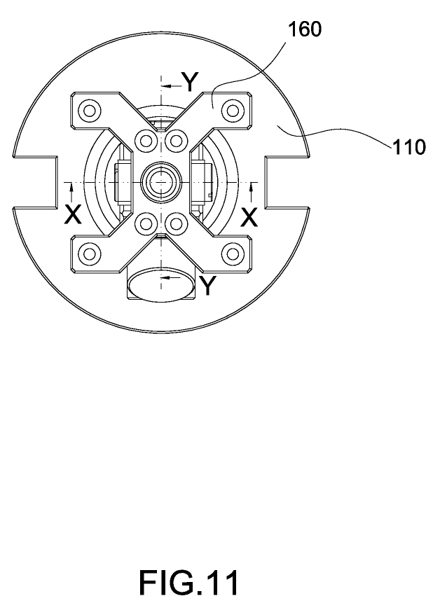

Referring to FIGS. 8 to 15, a pendulum-type measuring device in accordance with a second preferred embodiment of the invention is shown and comprises a disc-shaped base 110 having a staged central through hole 111 and four upward extending posts 112 with internal threads 1121 in which the posts 112 are arranged as a rectangle; a laser measuring assembly 120 comprising a body 122, a horizontal laser measuring member 121A and a vertical laser measuring member 121B both mounted on a front surface, and a top U-shaped yoke 123 having a through first threaded hole 1231 at either side; a joining member 140 adapted to swing and including a first hole 141 at either side and a second hole 142 at each of front and rear ends in which the first holes 141 are at a position lower than that of the second holes 142; an inverted U-shaped bridge 150 including a through second threaded hole 151 at each of front and rear ends and a plurality of threaded apertures 152 on four corners respectively; an X-shaped member 160 including a plurality of longitudinal through threaded holes 161 at four ends; a plurality of fasteners (e.g., screws) 170; and four joining assemblies 130 having a steel ball 131, two concave members 132, and a threaded fastener 133.

Assembly of the second preferred embodiment of the invention will be described in detail below. First, mount the body 122 of the laser measuring assembly 120 onto the through hole 111. Next, mount four concave members 132 in the first holes 141 and the second holes 142 respectively. Next, mount four steel balls 131 in the concave members 132 in the first holes 141 and the second holes 142 respectively. Next, mount the joining member 140 in the yoke 123. Next, mount another two concave members 132 in the first threaded holes 1231 to engage with the steel balls 131 respectively. Next, drive two threaded fasteners 133 into the first threaded holes 1231 respectively for securing the concave members 132 and the steel ball 131 together in which the steel ball 131 is adapted to rotate freely in a space defined by the opposite concave members 132. Next, place the bridge 150 onto both the joining member 140 and the yoke 123. Next, mount another two concave members 132 in the second threaded holes 151 to engage with the steel balls 131 in the joining member 140 respectively. Next, drive another two threaded fasteners 133 into the second threaded holes 151 respectively for securing the concave members 132 and the steel ball 131 together in which the steel ball 131 is adapted to rotate freely in a space defined by the opposite concave members 132. Next, drive the fasteners (e.g., screws) 170 through the threaded holes 161 of the X-shaped member 160 into the threaded apertures 152 of the bridge 150 and into the internal threads 1121 of the posts 112 respectively for mounting the X-shaped member 160. Finally, mount the vertical laser measuring members 121B and the horizontal laser measuring member 121A on the front surface of the body 122 in which an X-axis is formed by a line passing the first holes 141 and the first threaded holes 1231 and a Y-axis is formed by a line passing the second holes 142 and the second threaded holes 151.

It is seen that the base 110, the bridge 150 and the X-shaped member 160 are fixed and the remaining components including the laser measuring assembly 120 and the joining member 140 are adapted to swing as detailed later.

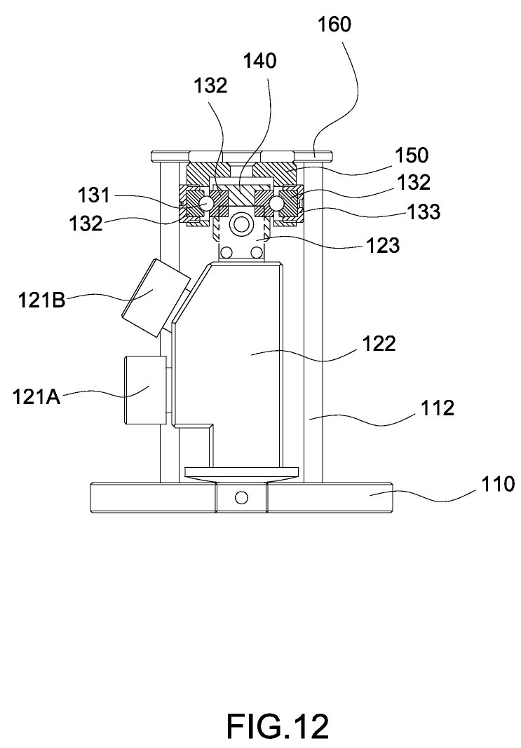

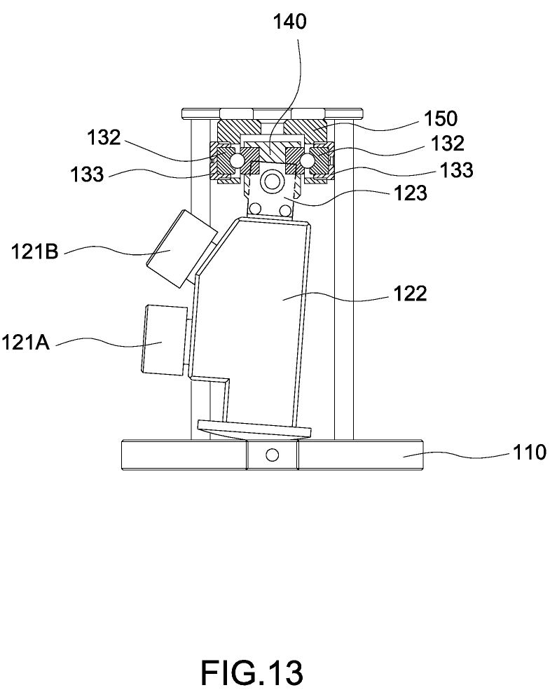

Referring to FIGS. 12 and 13 specifically, in a measuring operation the measuring device of the invention swings an angle which can be expressed as a horizontal component (i.e., swinging a first angle relative to X-axis) and a vertical component (i.e., swinging a second angle relative to Y-axis). In FIG. 12, a relative position of the yoke 123 of the laser measuring assembly 120 and the joining member 140 before swing is shown. Further, in FIG. 13, a relative position of the yoke 123 of the laser measuring assembly 120 and the joining member 140 after swinging a second angle relative to Y-axis is shown. It is seen that the vertical laser measuring member 121B and the horizontal laser measuring member 121A have swung relative to the Y-axis (see FIG. 13).

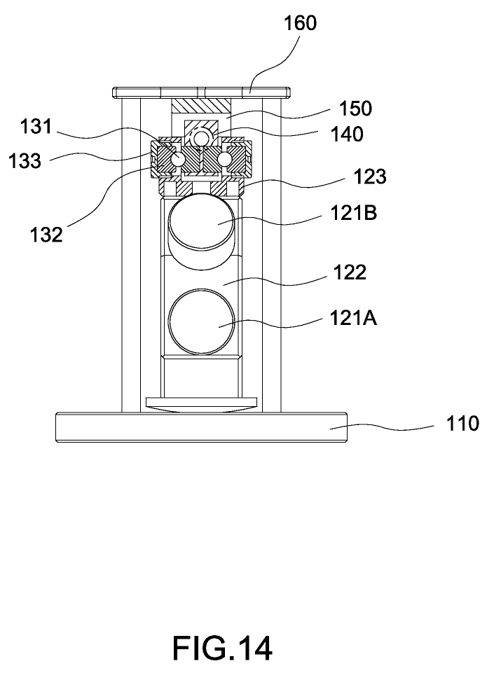

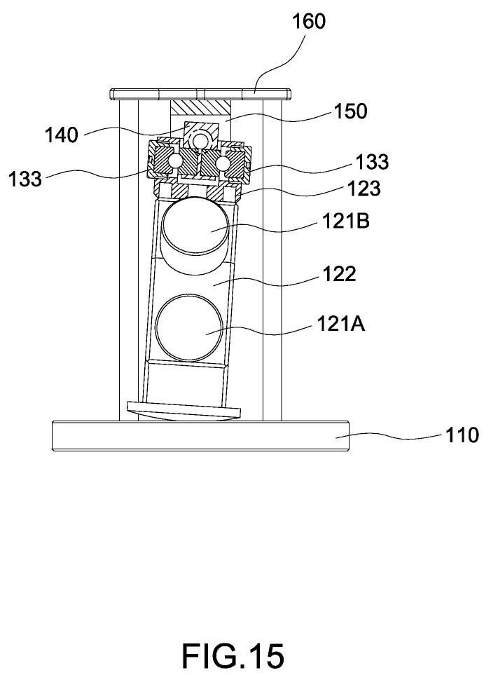

Referring to FIGS. 14 and 15 specifically in which in FIG. 14, a relative position of the laser measuring assembly 120, the joining member 140, and the bridge 150 before swing is shown. Further, in FIG. 15, a relative position of the laser measuring assembly 120, the joining member 140, and the bridge 150 after swinging a first angle relative to X-axis is shown. It is seen that the vertical laser measuring member 121B and the horizontal laser measuring member 121A have swung relative to the X-axis (see FIG. 15). As an end, horizontal and vertical lines for a measuring operation are obtained.

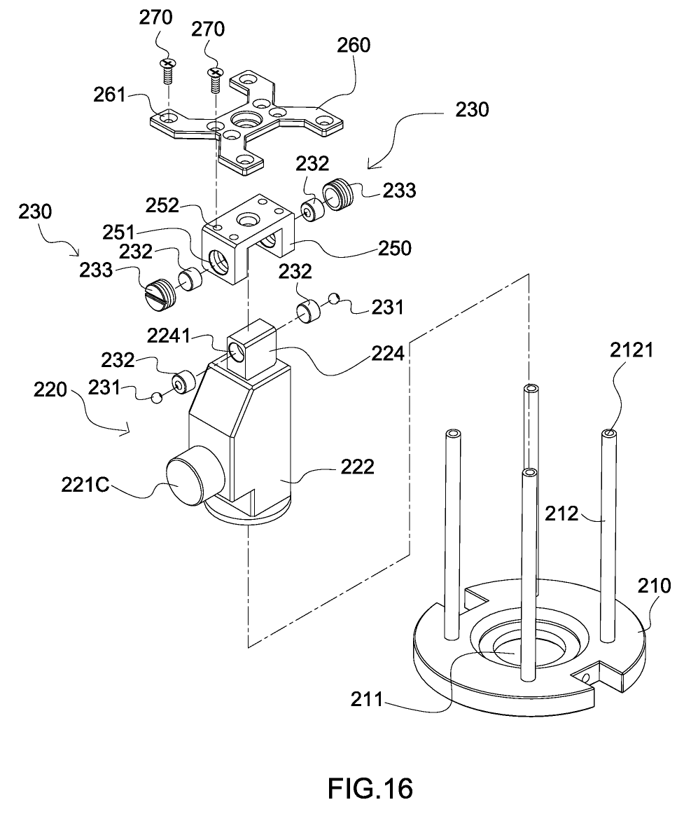

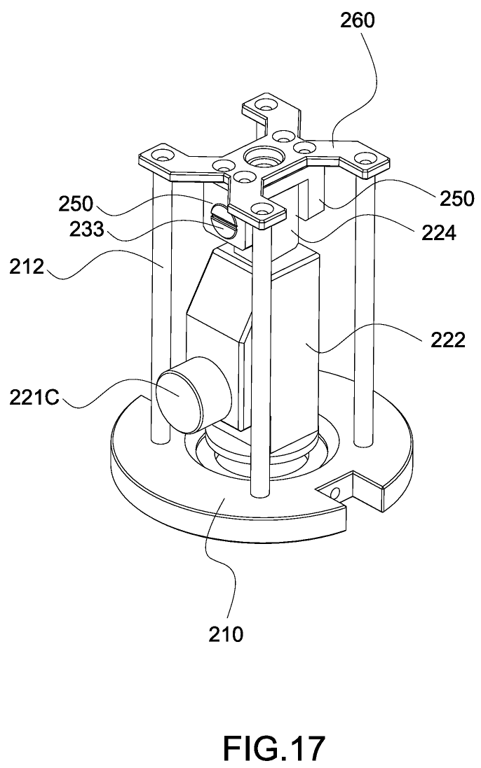

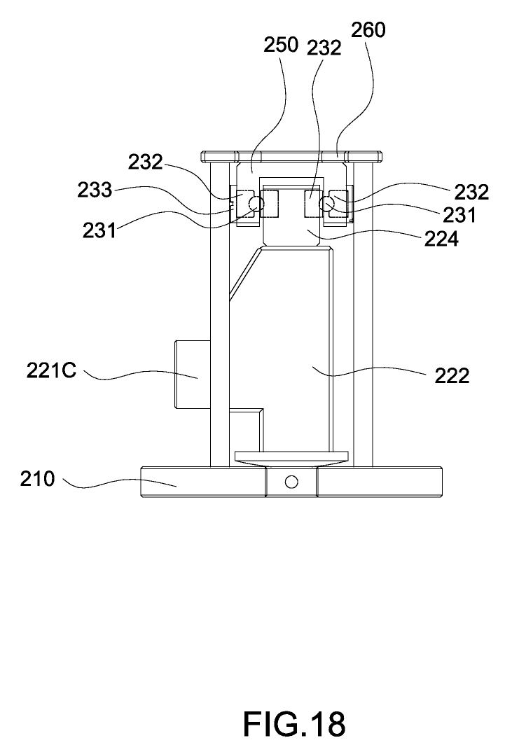

Referring to FIGS. 16 to 20, a pendulum-type measuring device in accordance with a third preferred embodiment of the invention is shown. The third preferred embodiment substantially is a simplification of the second preferred embodiment as detailed below. The joining member is eliminated. The number of the joining assemblies 230 is decreased from four to two. The number of the laser measuring member is one, namely, the vertical laser measuring member 221C. The yoke is replaced by a projection 224 having a hole 2241 at each of front and rear ends.

Assembly of the third preferred embodiment of the invention will be described in detail below. First, mount the body 222 of the laser measuring assembly 220 onto the through hole 211. Next, mount two concave members 232 in the holes 2241 respectively. Next, mount two steel balls 231 in the concave members 232 in the holes 2241 respectively. Next, mount another two concave members 232 in the threaded holes 251 to engage with the steel balls 231 respectively. Next, drive two threaded fasteners 233 into the threaded holes 251 respectively for securing the concave members 232 and the steel ball 231 together in which the steel ball 231 is adapted to rotate freely in a space defined by the opposite concave members 232. Next, drive the fasteners (e.g., screws) 270 through the threaded holes 261 of the X-shaped member 260 into the threaded apertures 252 of the bridge 250 and into the internal threads 2121 of the posts 212 respectively for mounting the X-shaped member 260. Finally, mount the vertical laser measuring members 221C on the front surface of the body 222 in which a Y-axis is formed by a line passing the holes 2241 and the threaded holes 251.

It is seen that the base 210, the bridge 250 and the X-shaped member 260 are fixed and the remaining component (e.g., the laser measuring assembly 220) is adapted to swing as detailed later.

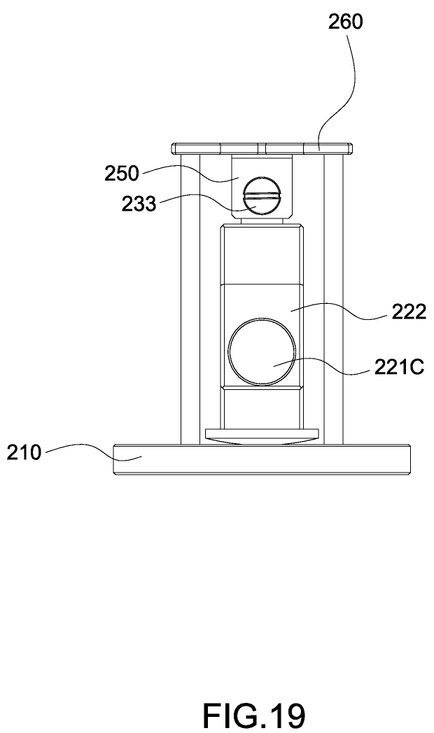

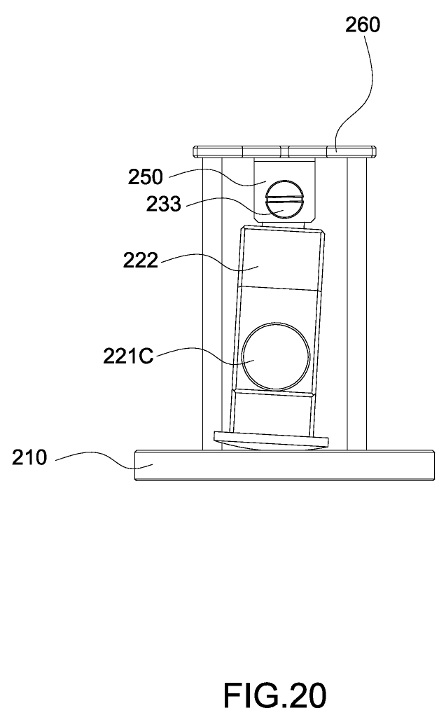

Referring to FIGS. 19 and 20 specifically, in a measuring operation the measuring device of the invention swings an angle relative to X-axis. In FIG. 29, a relative position of the laser measuring assembly 220 and the bridge 250 before swing is shown. Further, in FIG. 20, a relative position of the laser measuring assembly 220 and the bridge 250 after swinging an angle relative to X-axis is shown. It is seen that the vertical laser measuring members 221C have swung relative to the X-axis (see FIG. 20).

While the invention herein disclosed has been described by means of specific embodiments, numerous modifications and variations could be made thereto by those skilled in the art without departing from the scope and spirit of the invention set forth in the claims.

What is claimed is:

1. A measuring device comprising:
a base (10) having a top plate (50);
an outer ring (20) pivotably fastened under the plate (50); and
an inner ring (30) pivotably secured to the outer ring (20),
wherein the inner ring (30) is adapted to swing relative to an X-axis and a Y-axis, and the inner ring (30) is further adapted to swing relative to the X-axis and the Y-axis about the outer ring (20).

2. The measuring device of claim 1, wherein the outer ring (20) comprises four equally spaced apart weights (24) disposed on the circumferential surface.

3. The measuring device of claim 1, further comprising a plurality of joining assemblies (60) for enabling the inner ring (30) to swing relative to the X-axis and the Y-axis, and further enabling the inner ring (30) to swing relative to the X-axis and the Y-axis about the outer ring (20).

4. The measuring device of claim 3, further comprising a bridge (40) secured to the base (10), the bridge (40) comprising a cylinder (41) extending downward from its center, wherein the number of the joining assemblies (60) is four, and wherein each joining assemblies (60) comprises a steel ball (61), a pair of concave members (62), and a threaded fastener (63).

5. The measuring device of claim 4, wherein two of the concave members (62) are disposed in the cylinder (41) and are aligned with each other, another two of the concave members (62) are disposed in the inner ring (30) and are aligned with each other, two of the steel balls (61) each is rotatably disposed in space defined by the pair of concave members (62), and two of the threaded fasteners (63) each is driven into the inner ring (30) to rotatably secure the inner ring (30) and the cylinder (41) together;
and wherein another two of the concave members (62) are disposed in the inner ring (30) and are aligned with each other, another two of the concave members (62) are disposed in the outer ring (20) and are aligned with each other, another two of the steel balls (61) each is rotatably disposed in space defined by the pair of concave members (62), and another two of the threaded fasteners (63) each is driven into the outer ring (20) to rotatably secure the inner ring (20) and the inner ring (30) together.

6. The measuring device of claim 1, further comprising one or more laser measuring members (51, 52) disposed on the top plate (50).

7. A measuring device comprising:
a support assembly (110, 150, 160);
a joining member (140) adapted to swing and pivotably fastened in the support assembly (110, 150, 160); and
a laser measuring assembly (120) suspended under the joining member (140),
wherein the joining member (140) is adapted to swing relative to an X-axis and a Y-axis about the support assembly (110, 150, 160), and the joining member (140) is further adapted to swing relative to the X-axis and the Y-axis about the laser measuring assembly (120).

8. The measuring device of claim 7, further comprising a plurality of joining assemblies (130) for enabling the joining member (140) to swing relative to the X-axis and the Y-axis about the support assembly (110, 150, 160) and further enabling the joining member (140) to swing relative to the X-axis and the Y-axis about the laser measuring assembly (120).

9. The measuring device of claim 8, wherein the support assembly (110, 150, 160) comprises a base (110) having a plurality of upward extending posts (112), an X-shaped member (160) mounted on the posts (112), and an inverted U-shaped bridge (150) secured under the X-shaped member (160) and including a through second threaded hole (151) at each of the front and the rear ends; wherein the laser measuring assembly (120) comprises a body (122) and a U-shaped yoke (123) on a top of the body (122), the yoke (123) having a through first threaded hole (1231) at either side; wherein the joining member (140) is a parallelepiped and comprises a first hole (141) at either side and a second hole (142) at each of the front and the rear ends, the first holes (141) being at a position lower than that of the second holes (142); and wherein each joining assemblies (130) comprises a steel ball (131), a pair of concave members (132), and a threaded fastener (133).

10. The measuring device of claim 9, wherein two of the concave members (132) are disposed in the second threaded holes (151) and are aligned with each other, another two of the concave members (132) are disposed in the first threaded holes (1231) and are aligned with each other, another four of the concave members (132) are disposed in the first holes (141) and the second holes (142), two of the steel balls (131) each is rotatably disposed in space defined by the first pair of concave members (132) in both the yoke (123) and the joining member (140), another two of the steel balls (131) each is rotatably disposed in space defined by the second pair of concave members (132) in both the bridge (150) and the joining member (140), two of the threaded fasteners (133) each is driven into the first threaded hole (1231) to rotatably secure the laser measuring assembly (120) and the joining member (140) together, and another two of the threaded fasteners (133) each is driven into the second threaded hole (151) to rotatably secure the bridge (150) and the joining member (140) together.

11. The measuring device of claim 7, further comprising one or more laser measuring members (121A, 121B) disposed on the front surface of the body (122).

12. A measuring device comprising:
a support assembly (210, 250, 260); and
a laser measuring assembly (220) suspended under the support assembly (210, 250, 260),
wherein the laser measuring assembly (220) is adapted to swing relative to an X-axis about the support assembly (210, 250, 260).

13. The measuring device of claim 12, further comprising a plurality of joining assemblies (230) for enabling the laser measuring assembly (220) to swing relative to the X-axis about the support assembly (210, 250, 260).

14. The measuring device of claim 13, wherein the support assembly (210, 250, 260) comprises a base (210) having a plurality of upward extending posts (212), an X-shaped member (260) mounted on the posts (212), and an inverted U-shaped bridge (250) secured under the X-shaped member (260) and including a through threaded hole (251) at each of the front and the rear ends; wherein the laser measuring assembly (220) comprises a body (222) and a projection (224) on the top of the body (222), the projection (224) having a hole (2241) at each of the front and the rear ends; wherein the number of the joining assemblies (230) is two, and wherein each joining assembly (230) comprises a steel ball (231), a pair of concave members (232), and a threaded fastener (233).

15. The measuring device of claim 14, wherein two of the concave members (232) are disposed in the threaded holes (251) and are aligned with each other, another two of the concave members (232) are disposed in the holes (2241) and are aligned with each other, two of the steel balls (231) each is rotatably disposed in space defined by either pair of concave members (232), and two of the threaded fasteners (233) each is driven into the threaded hole (251) to rotatably secure the laser measuring assembly (220) and the bridge (250) together.

16. The measuring device of claim 12, further comprising at least one laser measuring member (221C) disposed on the front surface of the body (222).
